(19) United States
(12) Patent Application Publication
(10) Pub. No.: US 2010/0012635 A1
(43) Pub. Date: Jan. 21, 2010

(54) VISUALLY DESIGNATED USER INTERFACE FOR WELDER

(75) Inventors: Christopher Jay Wierschke, Greenville, WI (US); John Carmen Granato, JR., Greenville, WI (US)

Correspondence Address: FLETCHER YODER (ILLINOIS TOOL WORKS INC.), P.O. BOX 692289, HOUSTON, TX, 77269-2289, US

(73) Assignee: Illinois Tools Works Inc., Glenview, IL (US)

(21) Appl. No.: 12/467,843

(22) Filed: May 18, 2009

Related U.S. Application Data
(60) Provisional application No. 61/080,843, filed on Jul. 15, 2008.

(51) Int. Cl. B23K 9/10

(52) U.S. Cl. 219/130.1; 219/137 PS; 219/137 R

(57) ABSTRACT

Systems and methods for optimally setting a coarse adjustment knob and a fine adjustment knob (i.e. a rheostat) on a user interface of a stick welding system via an intuitive display are provided. Certain embodiments of the present disclosure relate to achieving the correct amperage setting for a given electrode through icons that allow easy association between an electrode and the proper coarse and fine adjustment knob settings. In one embodiment, the user interface includes a color coded bar chart that may be used to identify the proper coarse and fine adjustment knob settings for a given electrode. In another embodiment, the user interface includes panels above the coarse adjustment knob that contain icons with arrows that indicate an appropriate range of rheostat settings for a given electrode. Additionally, methods that may be used to set the coarse and fine adjustment knobs on the disclosed exemplary interfaces are provided.

### CROSS REFERENCE TO RELATED APPLICATIONS

This application is a U.S. Non-provisional patent application of U.S. Provisional Patent Application No. 61/080,843, entitled “Color Coded Bar Chart User Interface for Welder”, filed Jul. 15, 2008, which is herein incorporated by reference.

### BACKGROUND

The present disclosure relates generally to user interfaces of welding systems, and more particularly to systems and methods for optimally setting a coarse adjustment knob and a fine adjustment knob (i.e. a rheostat) on a user interface of a stick welding system via an intuitive display.

Stick welding is a process that has increasingly become ubiquitous in all industries. While such processes may be automated in certain contexts, a large number of applications continue to exist for manual welding operations, the success of which relies heavily on the welder choosing the proper amperage setting for the chosen stick electrode. For instance, an improper amperage setting can lead to sagging welds, arc loss and overall poor weldments. However, even experienced welders often have difficulty achieving the proper amperage setting during welding since both the coarse adjustment knob and the fine adjustment knob must be properly set for a given electrode to operate at the correct amperage setting. Furthermore, amperage displays typically do not exist on stick welding system interfaces, making it difficult for the user to know what the amperage setting is and whether it is within the range recommended by the manufacturer.

Traditionally, welders rely on experience and the look of the weld to approximate the proper amperage setting for a given electrode. It is now recognized that such traditional methods may lead to welders operating outside of the amperage setting range recommended by the manufacturer for a given electrode. Additionally, it is now recognized that traditional methods present difficulties for inexperienced welders who may waste time and wear down materials trying to find the proper amperage setting for the chosen electrode.

### BRIEF DESCRIPTION

The present disclosure is directed to systems and methods relating to user interfaces of welding systems. Certain embodiments of the present disclosure relate to achieving the correct amperage setting for a given electrode through icons that allow easy association between an electrode and the proper coarse and fine adjustment knob settings. In particular, the present disclosure relates to systems and methods for optimally setting a coarse adjustment knob and a fine adjustment knob (e.g. a rheostat) on a user interface of a stick welding system via an intuitive display. In one embodiment, the user interface includes a visually coded (e.g., color coded or pattern coded) bar chart that may be used to identify the proper coarse and fine adjustment knob settings for a given electrode. In another embodiment, the user interface includes panels above the coarse adjustment knob that contain icons with arrows that indicate an appropriate range of rheostat settings for a given electrode. Additionally, methods that may be used to set the coarse and fine adjustment knobs on the disclosed exemplary interfaces are provided.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an exemplary stick welding power supply unit in accordance with aspects of the present disclosure;

FIG. 2 illustrates an exemplary control panel including a visually coded bar chart, a coarse adjustment knob, and a rheostat in accordance with aspects of the present disclosure;

FIG. 3 illustrates an exemplary method of operating the exemplary control panel of FIG. 2 to optimally set an amperage setting for a chosen electrode in accordance with aspects of the present disclosure;

FIG. 4 illustrates an exemplary control panel including a low setting panel and a high setting panel above a coarse adjustment knob and a rheostat in accordance with aspects of the present disclosure; and

FIG. 5 illustrates an exemplary method of operating the exemplary control panel of FIG. 4 to optimally set an amperage setting for a chosen electrode in accordance with aspects of the present disclosure.

### DETAILED DESCRIPTION

It is now recognized that experience and the look of a weld may form an insufficient basis for a user to correctly determine the proper amperage setting for a given stick electrode. Additionally, it is now recognized that users often expend valuable time and effort trying to achieve the amperage setting recommended by the manufacturer for the chosen electrode. Accordingly, the present disclosure facilitates fast and easy setup of the correct amperage setting by visually and intuitively communicating knob settings that achieve the desired amperage setting for commonly used stick electrodes. The present disclosure may reduce the amount of time sales personnel, rental agents, and trainers spend teaching others how to properly use the system due to its convenience and simplicity.

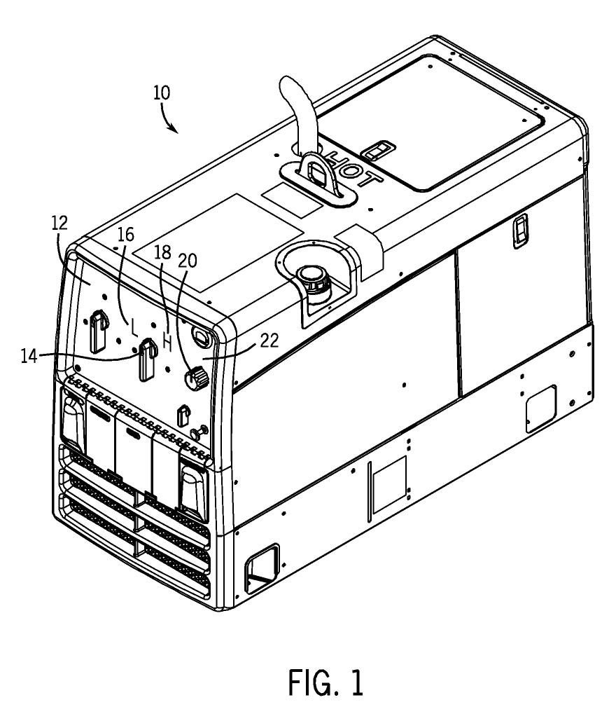

FIG. 1 illustrates an exemplary stick welding power supply 10, which functions to power, control, and provide consumables to a welding operation in accordance with aspects of the present disclosure. The front side of the power supply unit 10 in the illustrated embodiment contains a control panel 12, through which a user may control the supply of materials, such as power, gas flow, and so forth for a welding operation. In some embodiments, ports on the control panel 12 may allow the user to connect equipment to the power supply unit 10. A coarse adjustment knob 14 may allow the user to choose between usable current level settings, such as a low current level (e.g 50-120 Amps) setting, as indicated by a low setting panel 16 and a high current level (e.g. 70-200 Amps) setting, as indicated by a high setting panel 18. A rheostat 20 (e.g. a fine adjustment knob) may allow the user to fine tune the current output by varying the orientation of the rheostat 20 relative to a fine adjustment panel. For instance, there may be 10 settings on the rheostat 20 that each correspond to a single additional Amp that will be output (e.g. the first setting adds 1 additional Amp to the overall output, the second setting adds 2 additional Amps to the overall output, and so forth). Together, the coarse adjustment knob 14 and the rheostat 20 are configured to set the overall amperage output for the welding operation. For example, if the desired current output is 52 Amps, the coarse adjustment knob 14 may be set to 50 Amps, and the rheostat 20 may be set to output 2 Amps, achieving the overall output of 52 Amps. The user may need to adjust the coarse adjustment knob 14 and the rheostat 20 between welds since the desired overall output may be different for different processes. In some embodiments, the power supply unit 10 may be portable and may be communicatively coupled to additional system components, such as a wall power outlet, a battery, and so forth.

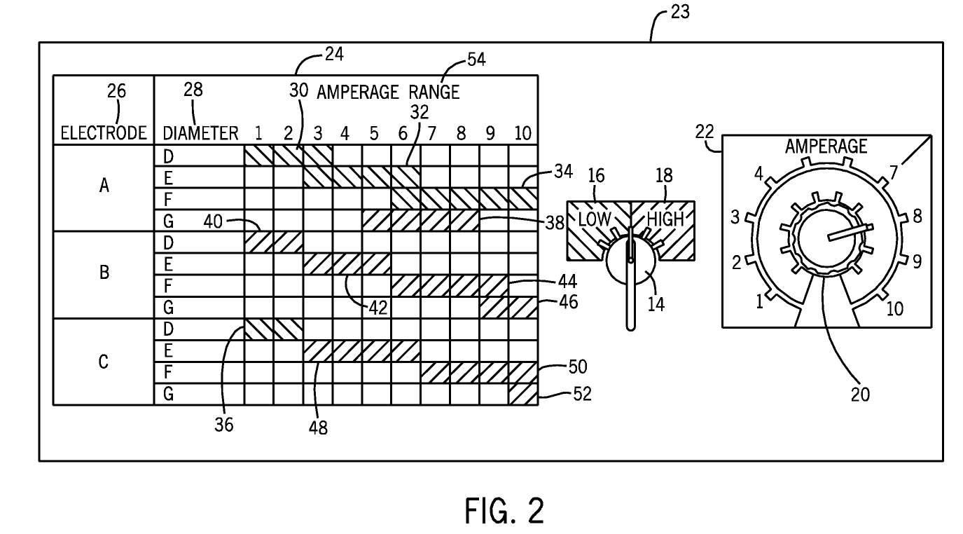

In accordance with the present disclosure, the power supply unit 10 provides exemplary control panels 12 that allow the user to easily associate a chosen electrode with the correct coarse adjustment setting and the correct range of fine tuned settings to achieve the amperage setting recommended by the manufacturer for the chosen electrode. FIG. 2 illustrates one such exemplary control panel 23 that includes a visually coded bar chart 24, the coarse adjustment knob 14 with the high setting and the low setting options, which are indicated to the user by the low setting panel 16 and the high setting panel 18, and the rheostat 20 with ten possible fine tuning settings on the fine tuning panel 22. It should be noted that when the user sets the coarse adjustment knob 14 to a position pointing to the low setting panel 16 or the high setting panel 18, internal components of the power supply unit 10 are configured to facilitate proper adjustment of the power supply 10 output. For example, in some embodiments, when the knob 14 is pointing to the high setting panel 18, internal components of the power supply unit 10 output current at a higher amperage than when the knob 14 is pointing to the low setting panel 16.

The bar chart 24 informs the user of an optimal coarse adjustment knob 14 setting and an optimal rheostat 20 setting for a given electrode 26 with a given diameter 28 as described in more detail below. In the illustrated embodiment, visual references to electrodes A, B, and C with diameters D, E, F, and G are shown for descriptive purposes. However, one skilled in the art would understand that the electrode labels A, B and C may be any electrode models, such as 6010, 6011, 6013, 7018 and so forth, used in industrial practice. Similarly, diameters D, E, F and G are shown for explanatory purposes and may be any electrode diameter size, such as 3/32″, ⅛″, 5/32″, 3/16″ and so forth, used in industrial practice. Additionally, the illustrated amperage range from 1 to 10 corresponds to the 10 distinct positions in which the illustrated rheostat 20 may be placed. However, the ten markings are shown for descriptive purposes. In other embodiments, the rheostat 20 and the corresponding amperage range may contain more or less markings that represent smaller or larger amperage increments as the rheostat 20 is turned.

The illustrated bar chart 24 includes a 10 by 12 grid in which each horizontal row corresponds to a particular electrode 26 and diameter 28 combination. For instance, the first row of the grid corresponds to electrode A and diameter D, the second row of the grid corresponds to electrode A and diameter E, and so forth. Each vertical column of the grid in the bar chart 24 corresponds to an amperage setting. For instance, the first vertical column corresponds to a 1 position setting, the second vertical column corresponds to a 2 position setting, and so forth. In the embodiment illustrated in FIG. 2, each horizontal row in the grid contains a shaded or hatched bar that is designed to convey two pieces of information to the user, the proper coarse adjustment knob 14 setting and the proper range of rheostat 20 settings for a given electrode with a given diameter. First, the shaded or hatched feature of the bar is configured to convey to the user whether to arrange the coarse adjustment knob 14 such that it lines up with the low setting panel 16 or the high setting panel 18 for a given electrode with a given diameter. This is indicated by the correspondence between the visual nature (e.g. patterned, colored, shaded, and so forth) of the low setting panel 16 and the visual nature of the bar. For instance, shaded bar 30, associated with electrode A and diameter D, corresponds to a low setting 16 of the coarse adjustment knob 14, as indicated by the correspondence between the shaded nature of the low setting panel 16 and the shaded nature of bar 30. Similarly, shaded bar 32, associated with electrode A and diameter E, corresponds to a low setting 16 of the coarse adjustment knob 14, as indicated by the correspondence between the shaded nature of the low setting panel 16 and the shaded nature of bar 32. Also, shaded bar 34, associated with electrode A and diameter F, corresponds to a low setting 16 of the coarse adjustment knob 14, as indicated by the correspondence between the shaded nature of the low setting panel 16 and the shaded nature of bar 34. Additionally, shaded bar 36, associated with electrode C and diameter D, corresponds to a low setting 16 of the coarse adjustment knob 14, as indicated by the correspondence between the shaded nature of the low setting panel 16 and the shaded nature of bar 36.

The hatched nature of the high setting panel 18 of the coarse adjustment knob 14 may be used in the same manner. For instance, hatched bar 38, associated with electrode A and diameter G, corresponds to a high setting 18 of the coarse adjustment knob 14, as indicated by the correspondence between the hatched nature of the high setting panel 18 and the hatched nature of bar 38. Similarly, hatched bar 40, associated with electrode B and diameter D, corresponds to a high setting 18 of the coarse adjustment knob 14, as indicated by the correspondence between the hatched nature of the high setting panel 18 and the hatched nature of bar 40. Additionally, hatched bar 42, associated with electrode B and diameter E, corresponds to a high setting 18 of the coarse adjustment knob 14, as indicated by the correspondence between the hatched nature of the high setting panel 18 and the hatched nature of bar 42. Similarly, hatched bar 44, associated with electrode B and diameter F, corresponds to a high setting 18 of the coarse adjustment knob 14, as indicated by the correspondence between the hatched nature of the high setting panel 18 and the hatched nature of bar 44. Also, hatched bar 46, associated with electrode B and diameter G, corresponds to a high setting 18 of the coarse adjustment knob 14, as indicated by the correspondence between the hatched nature of the high setting panel 18 and the hatched nature of bar 46. Similarly, hatched bar 48, associated with electrode C and diameter E, corresponds to a high setting 18 of the coarse adjustment knob 14, as indicated by the correspondence between the hatched nature of the high setting panel 18 and the hatched nature of bar 48. Similarly, hatched bar 50, associated with electrode C and diameter F, corresponds to a high setting 18 of the coarse adjustment knob 14, as indicated by the correspondence between the hatched nature of the high setting panel 18 and the hatched nature of bar 50. Additionally, hatched bar 52, associated with electrode C and diameter G, corresponds to a high setting 18 of the coarse adjustment knob 14, as indicated by the correspondence between the hatched nature of the high setting panel 18 and the hatched nature of bar 52. It should be noted that while the illustrated embodiment utilizes hatched and shaded visual features, other embodiments may utilize various different patterns, colors, and the like.

With regards to the second piece of information that the bar conveys to the user, the location of the bar along an amperage range scale 54 corresponds to an optimal range of rheostat 20 settings to use with a particular electrode 26 and diameter 28. For instance, for electrode A with diameter D, an indicated amperage range of 1 to 3 on the grid corresponds to a rheostat 20 setting between 1 and 3. Similarly, for electrode A with diameter E, an indicated amperage range of 3 to 6 on the grid corresponds to a rheostat 20 setting between 3 and 6. Similarly, for electrode A with diameter F, an indicated amperage range of 6 to 10 on the grid corresponds to a rheostat 20 setting between 6 and 10. Additionally, for electrode A with diameter G, an indicated amperage range of 5 to 8 on the grid corresponds to a rheostat 20 setting between 5 and 8. Similarly, for electrode B with diameter D, an indicated amperage range of 1 to 2 on the grid corresponds to a rheostat 20 setting between 1 and 2. Also, for electrode B with diameter E, an indicated amperage range of 3 to 5 on the grid corresponds to a rheostat 20 setting between 3 and 5. Similarly, for electrode B with diameter F, an indicated amperage range of 6 to 9 on the grid corresponds to a rheostat 20 setting between 6 and 9. Similarly, for electrode B with diameter G, an indicated amperage range of 9 to 10 on the grid corresponds to a rheostat 20 setting between 9 and 10. Similarly, for electrode C with diameter D, an indicated amperage range of 1 to 2 on the grid corresponds to a rheostat 20 setting between 1 and 2. Similarly, for electrode C with diameter E, an indicated amperage range of 3 to 6 on the grid corresponds to a rheostat 20 setting between 3 and 6. Similarly, for electrode C with diameter F, an indicated amperage range of 7 to 10 on the grid corresponds to a rheostat 20 setting between 7 and 10. Similarly, for electrode C with diameter G, an indicated amperage range of 10 on the grid corresponds to a rheostat 20 setting of 10.

As described, the visually coded bar chart 24 therefore indicates the optimal coarse adjustment knob 14 setting and rheostat 20 setting to the user for a given electrode 26 with a given diameter 28. It should be noted that in other embodiments, the color of the bar associated with a chosen electrode model 26 and diameter 28 may correspond to the color of the coarse adjustment knob 14 setting recommended by the electrode manufacturer. Additionally, other patterns and/or visual indicators may be used in place of the colors or the hatched/shaded nature of the bars. In some embodiments, a physical indicator and/or a visual indicator may be used to indicate a correspondence between a low setting panel 16 or a high setting panel 18 and the bars. For instance, raised patterns may be placed in each grid box to indicate a physical bar (i.e. to indicate amperage range 1-2, two raised dots may be placed in a horizontal row).

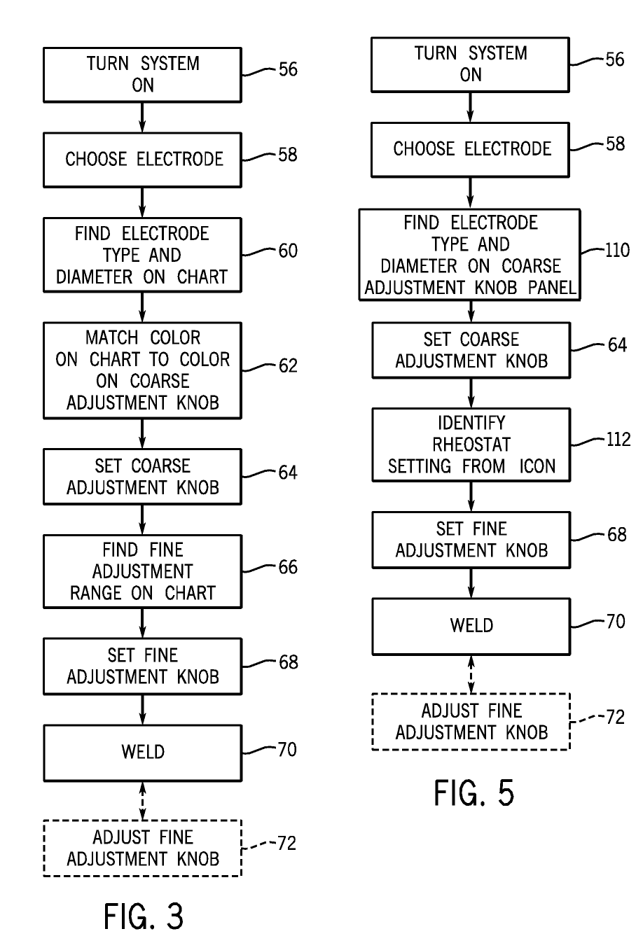

The present disclosure provides methods that may be employed by a user to properly set the amperage setting on a control panel, such as panel 23, in accordance with present embodiments. FIG. 3 includes a process flow diagram that is representative of a procedure for optimally setting the coarse adjustment knob 14 and the rheostat 20 for a given electrode 26 with a given diameter 28 using the exemplary control panel 23 of FIG. 2. Each block in FIG. 3 may represent a function or step. It should be noted that certain steps or functions may be performed in addition to those illustrated. Further, the illustrated functions or steps may be performed in a different order in accordance with present embodiments.

Specifically, in the illustrated embodiment of FIG. 3, the user first turns the system on, as represented by block 56, and chooses an electrode 26, as represented by block 58. The electrode 26 may be chosen by the user based on the parameters of the weld, such as the type of steel, the tensile strength of the workpiece, desired travel speed, and so forth. The user then finds the chosen electrode type 26 and diameter 28 on the chart, as represented by block 60, matches the color on the chart 24 to the color on the course adjustment knob 14, as represented by block 62, and sets the coarse adjustment knob 14 accordingly, as represented by block 64. In some embodiments, patterns or the like may be used in addition to or instead of colors. Subsequently, the user identifies the fine adjustment range suggested by the manufacturer for the given electrode 26 with a given diameter 28 from the chart 24, as represented by block 66, and sets the fine adjustment knob 20 accordingly, as represented by block 68. The user may then weld, as represented by block 70, adjusting the rheostat 20 within the range indicated by the bar associated with the given electrode 26 with the given diameter 28 as needed, as represented by block 72.

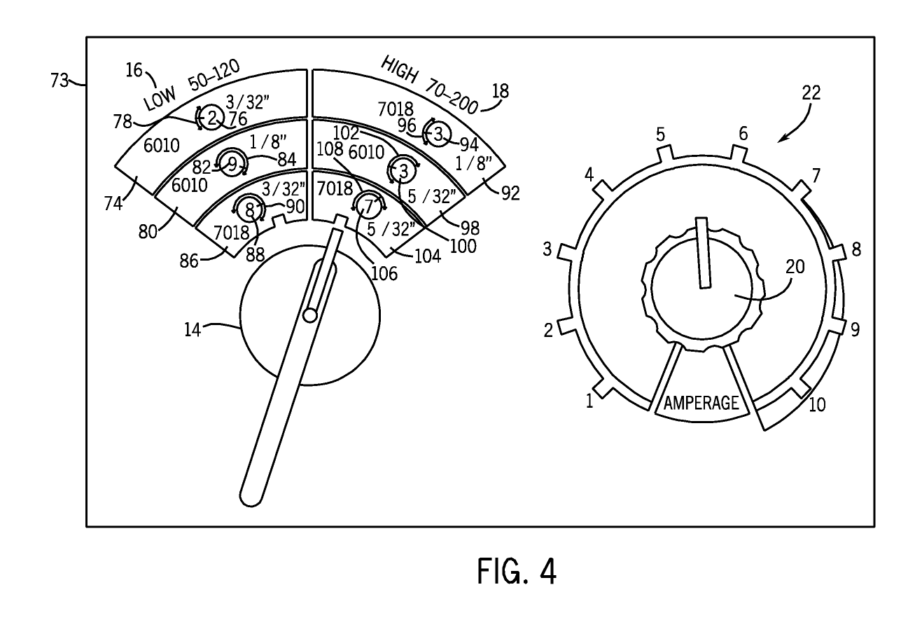

FIG. 4 illustrates an exemplary control panel 73 that allows the user to easily associate a chosen electrode with the correct coarse adjustment setting and the correct range of fine tuned settings to achieve the amperage setting recommended by the manufacturer for the chosen electrode. It should be noted that when the user sets the coarse adjustment knob 14 to a position pointing to the low setting panel 16 or the high setting panel 18, internal components of the power supply unit 10 are configured to facilitate proper adjustment of the power supply 10 output. For example, when the knob 14 is pointing to the high setting panel 18, internal components may output current at a higher amperage than when the knob 14 is pointing to the low setting panel 16. In the illustrated embodiment, the control panel 73 includes the coarse adjustment knob 14 with the high setting panel 18 and the low setting panel 16 and the rheostat 20 with ten possible fine tuning settings as represented by the numbers 1 through 10 on the fine adjustment panel 22. In the illustrated embodiment, there are three stick electrode types with associated diameters called out for each of the two coarse adjustment knob 14 setting panels 16, 18 for explanatory purposes. In other embodiments, more or less electrodes with associated diameters may be called out as desired. For example, additional electrode models, such as 6011, 6013 and so forth, may be called out on additional panels in certain embodiments. Similarly, additional diameters, such as 3/16″, may be called out on additional panels in certain embodiments.

In the illustrated embodiment, a first panel 74 of the low setting panel 16 contains an icon 76, which indicates that for a 6010 electrode with a 3/32″ diameter, the user should set the rheostat 20 to a 2 position. Additionally, the icon 76 contains a curved arrow 78 that graphically indicates to the user a range (1-4) of rheostat 20 settings that may be used with the 6010 electrode with a 3/32″ diameter. Indeed, the arrow 78 is positioned relative to a circle component of the icon 76 such that there is a correspondence between the relative positioning of the arrow 78 with respect to the circle and positioning of the rheostat 20 to achieve the proper setting. Similarly, in the illustrated embodiment, a second panel 80 of the low setting panel 16 contains an icon 82, which indicates that for a 6010 electrode with a ⅛″ diameter, the user should set the rheostat 20 at a 9 position. Additionally, the icon 82 contains a curved arrow 84 that graphically indicates to the user a range (2-10) of rheostat 20 settings that may be used with the 6010 electrode with a ⅛″ diameter. Similarly, in the illustrated embodiment, a third panel 86 of the low setting panel 16 contains an icon 88, which indicates that for a 7018 electrode with a 3/32″ diameter, the user should set the rheostat 20 at an 8 position. Additionally, the icon 88 contains a curved arrow 90 that graphically indicates to the user a range (2-10) of rheostat 20 settings that may be used with the 7018 electrode with a 3/32″ diameter. In some embodiments, the curved arrows 78, 84, and 90 may also include numbers on each end that indicate the associated range.

The high setting panel 18 of the coarse adjustment knob 14 may be used in much the same way as the low setting 16. In the illustrated embodiment, a first panel 92 of the high setting panel 18 contains an icon 94, which indicates that for a 7018 electrode with a ⅛″ diameter, the user should set the rheostat 20 to a 3 position. Additionally, the icon 94 contains a curved arrow 96 that graphically indicates to the user a range (1-5) of rheostat 20 settings that may be used with the 7018 electrode with a ⅛″ diameter. Similarly, in the illustrated embodiment, a second panel 98 of the high setting panel 18 contains an icon 100, which indicates that for a 6010 electrode with a 5/32″ diameter, the user should set the rheostat 20 at a 3 position. Additionally, the icon 100 contains a curved arrow 102 that graphically indicates to the user a range (1-8) of rheostat 20 settings that may be used with the 6010 electrode with a 5/32″ diameter. Similarly, in the illustrated embodiment, a third panel 104 of the high setting panel 18 contains an icon 106, which indicates that for a 7018 electrode with a 5/32″ diameter, the user should set the rheostat 20 at a 7 position. Additionally, the icon 106 contains a circular arrow 108 that graphically indicates to the user a range (3-9) of rheostat 20 settings that may be used with the 7018 electrode with a 5/32″ diameter. Again, in some embodiments, curved arrows may also include numbers on each end that indicate the associated range.

FIG. 5 illustrates exemplary methods that may be employed by the user to properly set the amperage output with the illustrated exemplary control panel 73 of FIG. 4. In particular, FIG. 5 illustrates exemplary logic that may be used for optimally setting the coarse adjustment knob 14 and the rheostat 20 for a given electrode 26 with a given diameter 28 using the exemplary control panel 73 of FIG. 4. Each block in FIG. 5 may represent a function or step. First, in the illustrated embodiment, the user turns the system on, as represented by block 56, and chooses an electrode 26, as represented by block 58. The electrode 26 may be chosen by the user based on the parameters of the weld, such as the type of steel, the tensile strength of the workpiece, desired travel speed, and so forth. The user then finds the electrode type 26 and diameter 28 on the coarse adjustment knob 14 panels, as represented by block 110 and sets the coarse adjustment knob 14 to the low setting 16 or the high setting 18 accordingly, as represented by block 64. Subsequently, the user identifies the fine adjustment setting suggested by the manufacturer for the given electrode 26 with a given diameter 28 from the icon on the panel, as represented by block 112, and sets the fine adjustment knob 20 accordingly, as represented by block 68. The user may then weld, as represented by block 70, adjusting the rheostat 20 as needed within the range indicated by the curved arrow above the icon associated with the given electrode 26 with the given diameter 28, as represented by block 72.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A stick welding power supply, comprising:
a control panel comprising:
a coarse adjustment knob, wherein a low setting of the coarse adjustment knob is indicated by a low setting panel having a first pattern and/or a first color and a high setting of the coarse adjustment knob is indicated by a high setting panel having a second pattern and/or a second color;
a rheostat, wherein the rheostat includes one or more fine tuning settings indicated by alphanumeric characters on a rheostat panel; and
a bar chart, wherein based on correspondence with the first pattern and/or color or the second pattern and/or color a pattern and/or color of a bar within the chart represents a coarse adjustment setting for an electrode of a type and a diameter indicated by type and diameter cells within the chart that are aligned with the bar, and wherein a location of the bar represents a range of rheostat settings indicated by alphanumeric characters.

2. The stick welding power supply system of claim 1, wherein the pattern of the bar associated with the electrode with the diameter matches the pattern of the correct coarse adjustment knob panel.

3. The stick welding power supply system of claim 1, wherein the color of the bar associated with the electrode with the diameter matches the color of the correct coarse adjustment knob panel.

4. The stick welding power supply system of claim 1, wherein the bar chart contains one or more electrode types.

5. The stick welding power supply system of claim 1, wherein the bar chart contains one or more diameters.

6. The stick welding power supply system of claim 1, wherein the alphanumeric characters on the rheostat panel each represent one or more Amps.

7. The stick welding power supply system of claim 1, wherein the pattern of the bar is physically encoded.

8. The stick welding power supply of claim 1, wherein an orientation of the coarse adjustment knob and an orientation of the rheostat define the power output of the stick welding power supply.

9. A stick welding power supply, comprising:
a control panel comprising:
a coarse adjustment knob;
a low setting panel comprising one or more sub-panels, wherein each sub-panel comprises alphanumeric characters indicating an electrode model, an electrode diameter, and an icon including a single digit indicative of an optimal fine tuning setting and an arrow indicative of an optimal fine tuning setting range;
a high setting panel comprising one or more sub-panels, wherein each sub-panel comprises alphanumeric characters indicating an electrode model, an electrode diameter, and an icon including a single digit indicative of an optimal fine tuning setting and an arrow indicative of an optimal fine tuning setting range;
a rheostat, wherein the rheostat includes one or more fine tuning settings indicated by alphanumeric characters on a rheostat panel;

10. The stick welding power supply system of claim 9, wherein the alphanumeric characters on the rheostat panel each represent one or more Amps.

11. The stick welding power supply of claim 9, wherein the arrow indicative of the optimal fine tuning setting range corresponds to the one or more fine tuning settings indicated by alphanumeric characters on the rheostat panel.

12. The stick welding power supply of claim 9, wherein the icon including a single digit indicative of the optimal fine tuning setting corresponds to one fine tuning setting indicated by one alphanumeric character on the rheostat panel.

13. The stick welding power supply of claim 9, wherein an orientation of the coarse adjustment knob and an orientation of the rheostat define the power output of the stick welding power supply.

14. The stick welding power supply of claim 9, wherein the alphanumeric characters are physically encoded.

15. A method of manufacturing a welding system, comprising:
providing a welding power supply;
providing a control panel on the welding power supply comprising:
a coarse adjustment knob, wherein a low setting of the coarse adjustment knob is indicated by a low setting panel having a first pattern or a first color and a high setting of the coarse adjustment knob is indicated by a high setting panel having a second pattern or a second color;
a rheostat, wherein the rheostat includes one or more fine tuning settings indicated by alphanumeric characters on a rheostat panel; and
a bar chart, wherein a pattern or color of a bar within the chart represents a coarse adjustment setting for an electrode of a type and a diameter indicated by type and diameter cells within the chart that are aligned with the bar, and wherein a location of the bar represents a range of rheostat settings indicated by alphanumeric characters.

16. The method of manufacturing the welding system of claim 15, wherein the pattern of the bar associated with the electrode with the diameter matches the pattern of the correct coarse adjustment knob panel.

17. The method of manufacturing the welding system of claim 15, wherein the color of the bar associated with the electrode with the diameter matches the color of the correct coarse adjustment knob panel.

18. The method of manufacturing the welding system of claim 15, wherein the bar chart is provided with one or more electrode types.

19. The method of manufacturing the welding system of claim 15, wherein the alphanumeric characters on the rheostat panel each represent one or more Amps.

20. The method of manufacturing the welding system of claim 15, wherein the pattern of the bar is physically encoded.
